(19) United States
(12) Patent Application Publication
(10) Pub. No.: US 2025/0350168 A1
(43) Pub. Date: Nov. 13, 2025

(54) Revolute Joint for Robot

(71) Applicant: Timeback Incorporated, Brooklyn, NY (US)

(72) Inventor: Mason Massie, Brooklyn, NY (US)

(21) Appl. No.: 19/077,635

(22) Filed: Mar. 12, 2025

Related U.S. Application Data
(60) Provisional application No. 63/644,797, filed on May 9, 2024.

(51) Int. Cl. H02K 7/116; B25J 17/00; B25J 19/00; H02K 7/10; H02K 11/21; H02K 13/00

(52) U.S. Cl. CPC H02K 7/116; B25J 17/00; B25J 19/0041; H02K 7/1004; H02K 11/21; H02K 13/003

(57) ABSTRACT

A revolute joint incorporates a planetary gear set, which may be nested with an electric motor. An axle of the planetary gear set turns a pulley that engages with a belt, which drives a pulley that turns an output shaft of the joint. In the joint output there is a coaxial slip ring that allows continuous rotation of the joint, meaning that output revolutions are not limited for maximum possible range of motion for the robot arm. The slip ring replaces dynamic cabling (which can fatigue over time), which is good for reliability/cycle life.

### TECHNICAL FIELD

This application relates to the electromechanical and electronic arts, and, more particularly, to joints for use in robots.

### BACKGROUND

Robots may be capable of lifting and moving objects, such as boxes in a warehouse. It may be helpful to have robots move in ways similar to human motion, because the human body is well-adapted to perform complex movement. Such motion is particularly necessary where a robot is controlled or executing movements programmed by a human operator. Moving in ways similar to human motion requires robots to have jointed limbs, in which one or more joints have multiple degrees of freedom.

### SUMMARY

This application discloses a revolute joint that incorporates a planetary gear set, which in some embodiments is nested with an electric motor. An axle of the planetary gear set turns a pulley that engages with a belt, which drives a pulley that turns an output shaft of the joint. In the joint output there is a coaxial slip ring that allows continuous rotation of the joint, meaning that output revolutions are not limited for maximum possible range of motion for the robot arm. The slip ring replaces dynamic cabling (which can fatigue over time as the cabling is flexed, resulting in failure of the conductor or sheathing or both), which is good for reliability/cycle life.

This type of joint has a very efficient and transparent transmission meaning that if input force from the motor is measurable and is measured, there is no need for an output force sensor. This reduces complexity and cost while improving dynamic performance. Thus, in some embodiments, the motor is controlled based on a signal from a rotary encoder that is associated with the rotor of the motor. In some embodiments, the motor is controlled based on a signal from a hall effect sensor that is associated with the rotor of the motor.

One revolution of the output results in multiple revolutions of the input (motor rotor) due to the reduction. This means that during regular operation “rollovers” of the input encoder (or hall effect sensor) are kept track of by the software so the final output position is known. However, if the input encoder is powered off and the output is backdriven, the input encoder or hall effect sensor may have “rolled over” without the software keeping track. This means that when the joint is powered on again, there will be some position error. To solve this problem, every time the robot is powered on it indexes the input encoder relative to the joint output. In some embodiments, software analyzes measurements from an inertial measurement unit (“IMU”) mounted to the joint output to determine its angle relative to gravity. In some embodiments, software analyzes measurements from a magnetometer mounted to the joint output to determine its angle relative to the earth's magnetic field. In some embodiments, the output joint is driven against a hard stop. In some embodiments there is a simple output encoder. In some embodiments there is a combination of two or more of the previously mentioned techniques. Using these methods reduces or eliminates requirements for an output encoder as a way to reduce complexity and cost.

### BRIEF DESCRIPTION OF THE DRAWINGS

FIG. 1A depicts an “exploded” view of an example revolute joint 100, according to an aspect of the disclosure.

FIG. 1B depicts a side view of the joint 100.

FIG. 1C depicts a sectional view of the joint 100.

FIG. 1D depicts a perspective view of the revolute joint 100.

FIG. 2A depicts an “exploded” view of an example revolute joint 200, according to an aspect of the disclosure.

FIG. 2B depicts a side view of the joint 200.

FIG. 2C depicts a sectional view of the joint 200.

FIG. 2D depicts a perspective view of the revolute joint 200.

FIG. 3A depicts an “exploded” view of an example revolute joint 300, according to an aspect of the disclosure.

FIG. 3B depicts a side view of the joint 300.

FIG. 3C depicts a sectional view of the joint 300.

FIG. 3D depicts a perspective view of the revolute joint 300.

FIG. 4A depicts a perspective view of a revolute joint 400.

FIG. 4B depicts an end view of the revolute joint 400.

FIG. 4C depicts a side view of the revolute joint 400.

FIG. 4D depicts a sectional view of the revolute joint 400.

FIG. 5A depicts an “exploded” view of a revolute joint 500 that includes a hose (either pneumatic or hydraulic) routed through a slip joint in the axle of the joint.

FIG. 5B depicts a perspective assembled view of the revolute joint 500.

FIG. 5C depicts a sectional view of the revolute joint 500.

### DETAILED DESCRIPTION

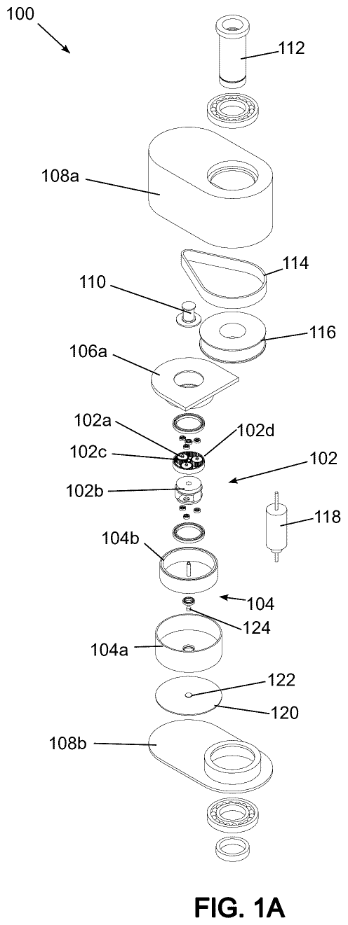

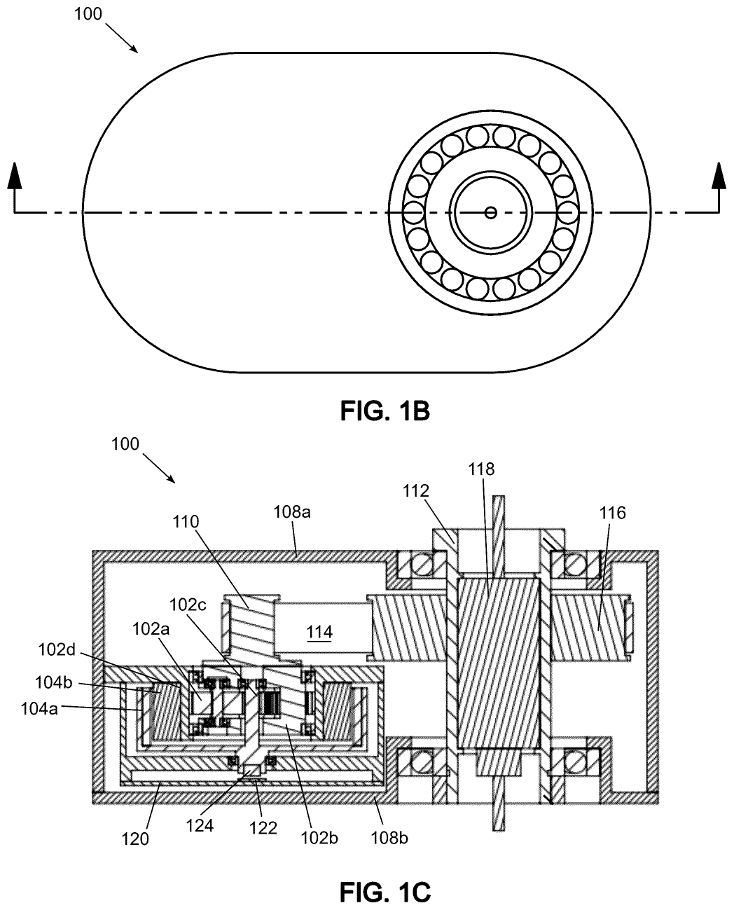

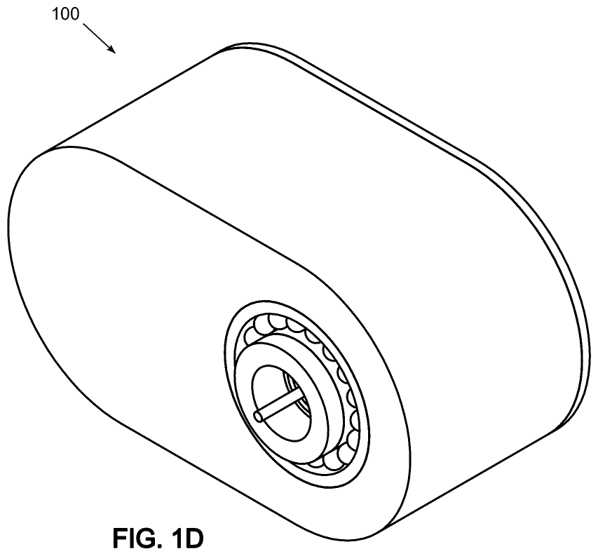

FIG. 1A depicts an “exploded” view of an example revolute joint 100, according to an aspect of the disclosure. The joint includes a planetary gear set 102 (comprising planet gears 102a on a planet carrier 102b, a sun gear 102c, and a ring gear 102d) and a motor 104 (comprising stator 104a and rotor 104b) that are enclosed by a casing 106a, 106b within a housing 108a, 108b. The gear set 102 turns a first pulley 110, which drives an output shaft 112a, 112b via a belt 114 and a second pulley 116. Inside the output shaft 112a, 112b there is a slip ring 118 that is coaxial with the output shaft. For example, the slip ring 118 may include two channels for power+, two channels for power−, one channel for CAN+, and one channel for CAN−. An inverter board 120 is mounted to the motor housing and is wired through the motor housing to the motor stator 104a. An encoder 122 is built into the inverter board such that the encoder is arranged in registry with an encoder target 124 that is disposed on the motor rotor 104b.

FIG. 1B depicts a side view of the joint 100.

FIG. 1C depicts a sectional view of the joint 100. As may be seen in FIG. 1C, the motor stator 104a and rotor 104b are nested with the planetary gear set 102. The stator 104a is fixed to the ring gear 102d within the casing 106a, 106b. The rotor 104b is attached to rotate with the sun gear 102c. The planet carrier 102b is attached to rotate with the first pulley 110.

The first pulley 110 may have teeth 110a which interact and mesh with corresponding teeth 114a on the belt 114. The motor 104 drives the planetary gear set 102, which drives the first pulley 110, which drives the output shaft 112a, 112b via the belt 114, to provide a revolute joint 100.

The stator 104a is wound with at least one coil. The rotor 104b is coaxial with the stator. The sun gear 102c is fixed to the rotor coaxial with the stator. The one or more planet gears 102a are rotatably attached to the planet carrier 102b and are meshed with the sun gear. The ring gear 102d surrounds and is meshed with the planet gears. The planet carrier 102b is attached to a driven shaft of the first pulley 110, which is rotatably connected coaxially with the stator. Alternatively, the planet carrier may be fixed to the stator and the ring gear may drive the first pulley.

Looking more closely at FIG. 1C, the rotor 104b comprises an annular flange 104c that carries magnets 104d adjacent to the stator. The magnets 104d mounted to the annular flange 104c produce a field that is measured by a hall effect encoder, according to an aspect of the disclosure. According to another aspect of the disclosure, a magnetic encoder or an optical encoder or a resistive or a capacitive encoder or inductive encoder may be used with an encoder target attached on the motor rotor.

There could be one or more tensioning mechanisms on any one or more of the first pulley 110 and output shaft 112a, 112b, the second pulley 116, the idler pulley 130, and the belt 114 itself. For example, the idler pulley 130 may be spring loaded to provide tension on the belt or may be affixed to the casing 106a, 106b or housing 108a, 108b with an eccentric or cammed fastener or the idler may be mounted on a “swingarm” that is preloaded with a jackscrew. Such a configuration is desirable where a significant load, relative to the power of the motor 104 or friction capacity of the belt 114, is applied to the joint and additional belt wrap about the first pulley 110 and second pulley 116 is beneficial or packaging constraints (e.g., thickness of the joint) limit the diameter of the belt. As another example, the first pulley 110 and second pulley 116 may be manually distanced from one another prior to the housing 108a, 108b being assembled, or a jack screw mechanism may be used to increase the distance. Such a configuration could be used where there is enough wrap angle around the pulley(s) given the geometry of the transmission, for example, to reduce the thickness of the joint 100 for space constraints. Such a configuration could also be used where a less significant load, relative to the power of the motor 104 or friction capacity of the belt 114, is applied to the joint and there is no need for additional belt wrap angle. Still other mechanisms or combinations of the aspects of the disclosure are possible to achieve the desired load and dimensional metrics of the joint.

In operation of the joint 100, there is an initial clocking process where a motor position is keyed to an arm position. For example, the clocking process might start with the arm perfectly horizontal, or at a min/max of rotation, and the motor encoder would record that position and wind up/down from there. Orientation relative to gravity is used for the joints past the shoulder joint. For example, if the shoulder is horizontal and the forearm is at a 45 deg angle upward, rotating the shoulder up 90 deg would mean the forearm is now 135 deg from horizontal.

FIG. 1D depicts a perspective view of the revolute joint 100.

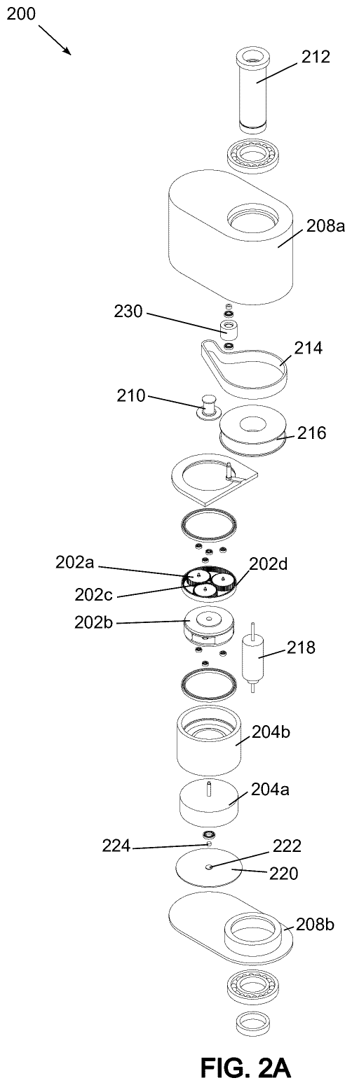

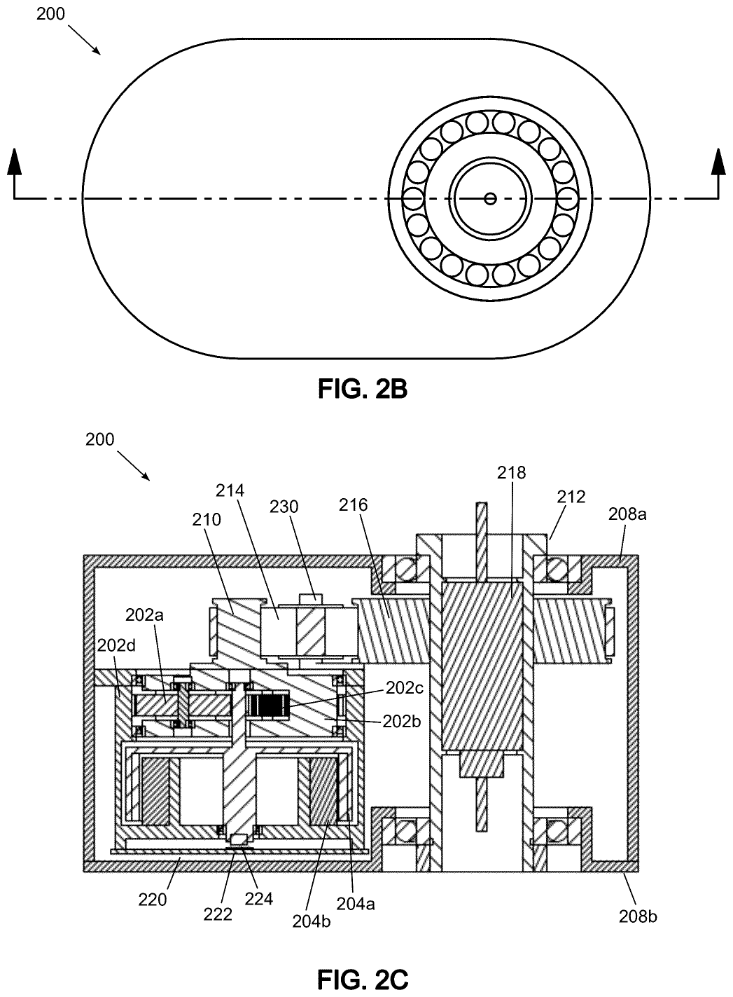

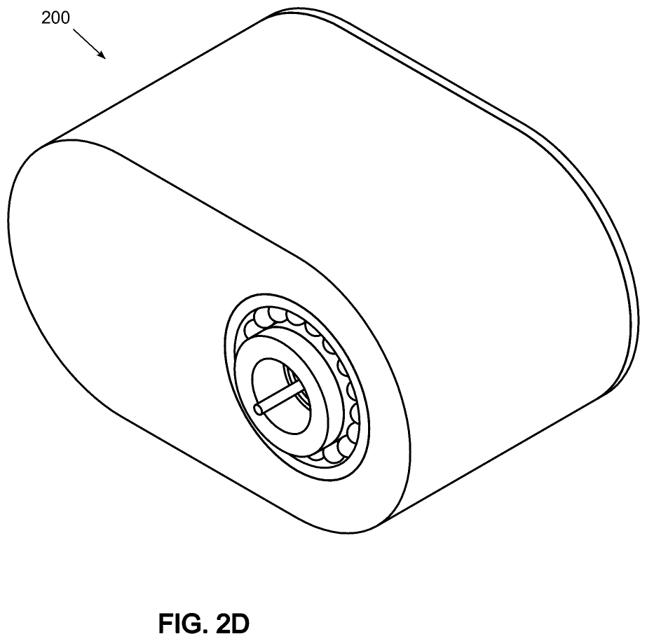

FIG. 2A depicts an “exploded” view of an example revolute joint 200, according to an aspect of the disclosure. Whereas the revolute joint 100 has the motor nested with the planetary gear set, the revolute joint 200 has the motor stacked outside of the planetary gear set. This makes the joint axially thicker but also makes it possible to get a larger reduction from the single stage gear set for a given strength. Components of the joint 200 that are similar to those of the joint 100 are numbered similarly but incremented by 100.

FIG. 2B depicts a side view of the joint 200.

FIG. 2C depicts a sectional view of the joint 200.

FIG. 2D depicts a perspective view of the revolute joint 200.

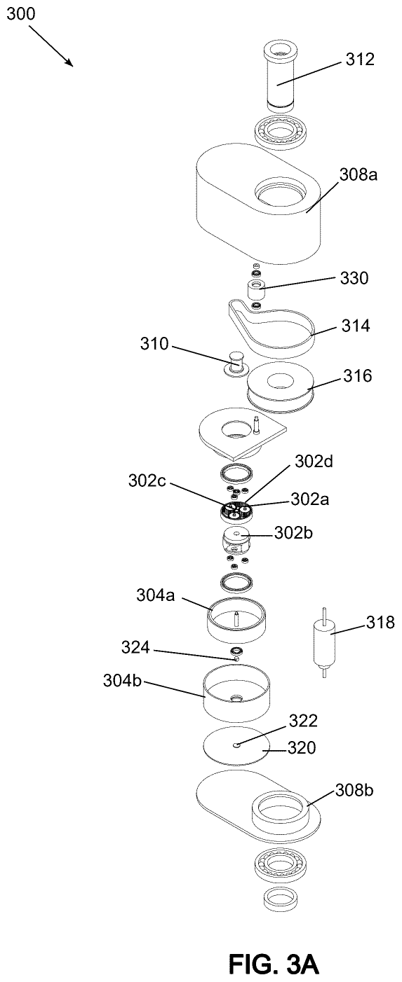

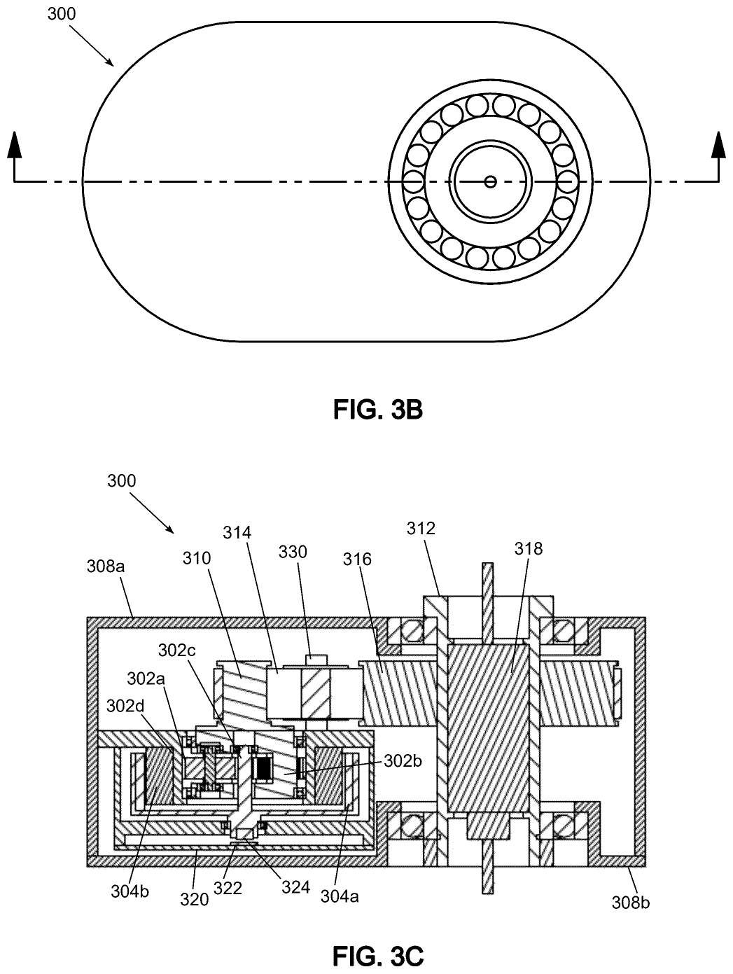

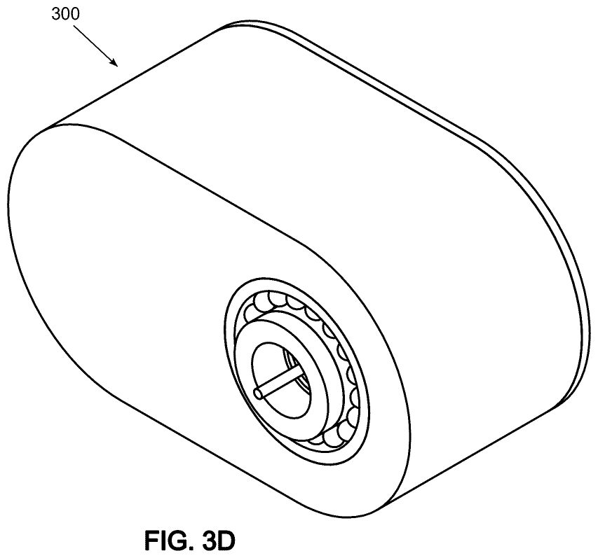

FIG. 3A depicts an “exploded” view of an example revolute joint 300, according to an aspect of the disclosure. Components of the joint 300 that are similar to those of the joint 200 are numbered similarly but incremented by 100.

FIG. 3B depicts a side view of the joint 300.

FIG. 3C depicts a sectional view of the joint 300.

FIG. 3D depicts a perspective view of the revolute joint 300.

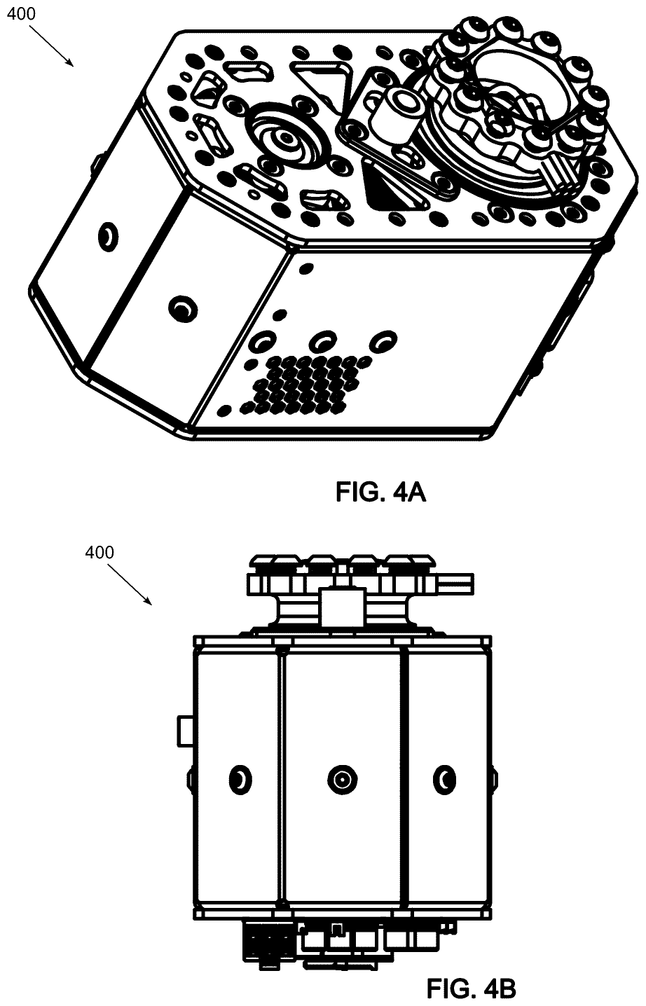

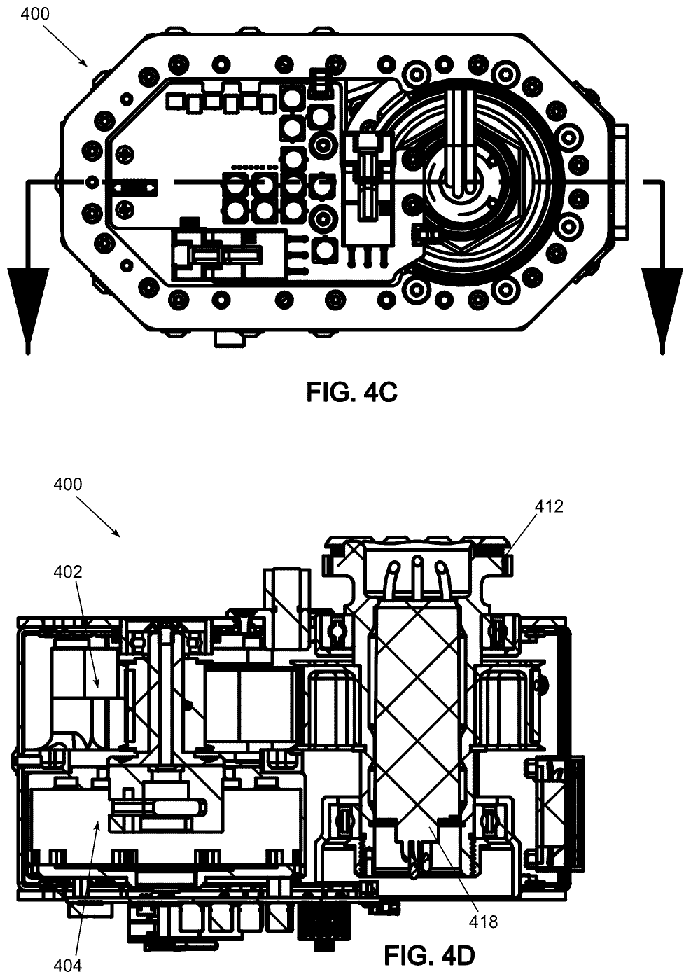

FIG. 4A depicts a perspective view of an example revolute joint 400, according to an aspect of the disclosure. Components of the joint 400 that are similar to those of the joint 300 are numbered similarly but incremented by 100.

FIG. 4B depicts an end view of the joint 400.

FIG. 4C depicts a side view of the joint 400.

FIG. 4D depicts a sectional view of the joint 400.

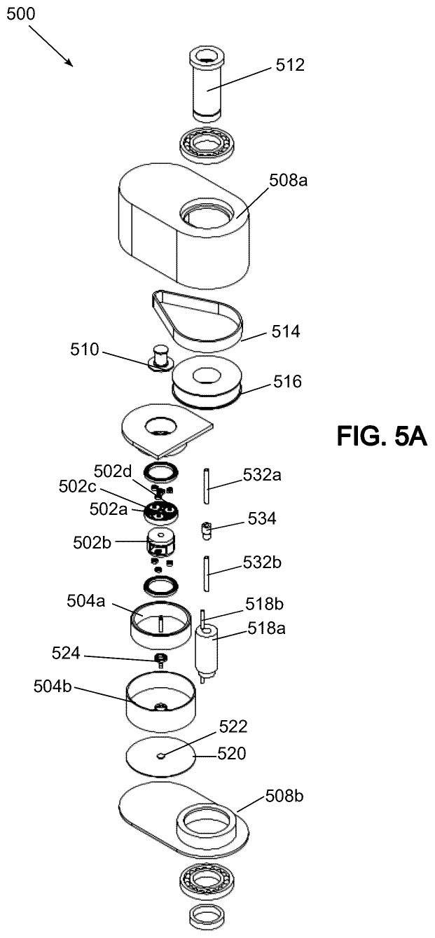

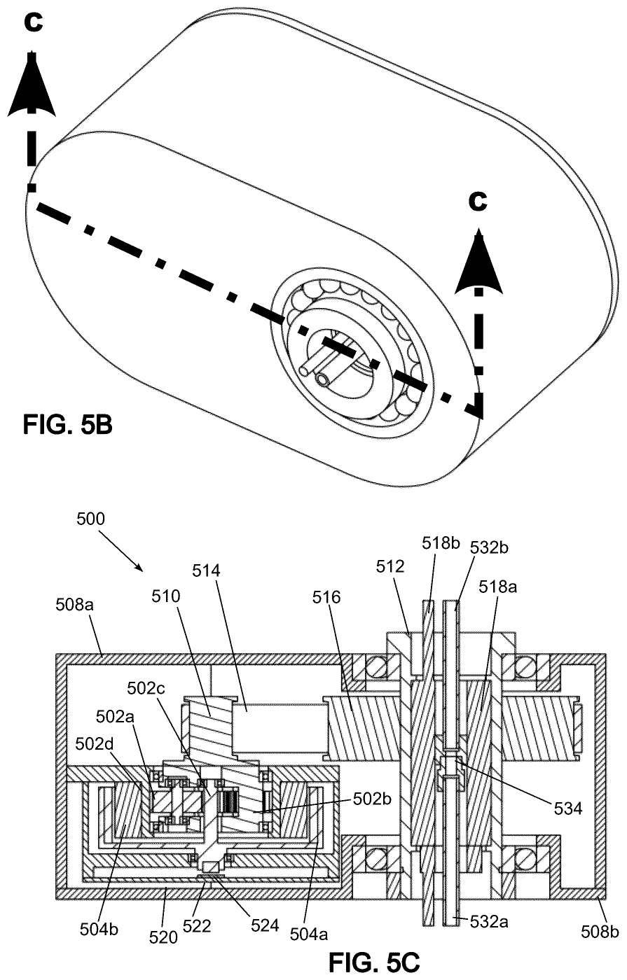

FIG. 5A depicts an “exploded” view of a revolute joint 500 that includes a hose (either pneumatic or hydraulic) routed through a fluid slip joint 534 in the axle of the joint, according to an aspect of the disclosure. Components of the joint 500 that are similar to those of the joint 300 are numbered similarly but incremented by 200. In addition to the fluid slip joint 534, the joint 500 also includes fluid hoses 532a, 532b. The fluid slip joint 534 may for example have a labyrinth seal to contain the pressurized fluid in the joint.

FIG. 5B depicts a perspective assembled view of the revolute joint 500.

FIG. 5C depicts a sectional view of the revolute joint 500.

What is claimed is:

1. A nested motor and planetary gearset apparatus comprising:
a stator that is wound with at least one coil;
a rotor that is coaxial with the stator;
a sun gear that is fixed to the rotor coaxial with the stator;
one or more planet gears that are rotatably attached to a planet carrier and that are meshed with the sun gear;
a ring gear that surrounds and is meshed with the planet gears; and
a driven shaft that is rotatably connected coaxially with the stator;
wherein one of the planet carrier or the ring gear is fixed to the driven shaft and the other of the planet carrier or the ring gear is fixed relative to the stator.

2. The apparatus of claim 1, wherein the rotor comprises an annular flange that carries magnets adjacent to the stator.

3. The apparatus of claim 1, further comprising a toothed pulley that is fixed to the driven shaft.

4. The apparatus of claim 1, further comprising:
a housing that encloses the stator, the rotor, and the gears, said housing being stationary relative to the stator; and
an inverter that is connected to the housing and is electrically connected to the stator coils.

5. The apparatus of claim 1, further comprising:
an encoder that is associated with the rotor.

6. The apparatus of claim 5, wherein the encoder is one of a Hall effect encoder, an optical encoder, a magnetic encoder, or an inductive, capacitive, or resistive type encoder.

7. A revolute joint comprising:
an apparatus having a stator that is wound with at least one coil;
a rotor that is coaxial with the stator;
a sun gear that is fixed to the rotor coaxial with the stator;
one or more planet gears that are rotatably attached to a planet carrier and that are meshed with the sun gear;
a ring gear that surrounds and is meshed with the planet gears; and
a driven shaft that is rotatably connected coaxially with the stator;
wherein one of the planet carrier or the ring gear is fixed to the driven shaft and the other of the planet carrier or the ring gear is fixed relative to the stator;
a housing that encloses the apparatus;
an output shaft that is rotatably mounted to the housing along an axis offset from the shaft of the apparatus;
an output pulley that is fixed to the output shaft;
a drive pulley that is fixed to the driven shaft of the apparatus; and
a toothed belt that is meshed with the drive pulley and the output pulley.

8. The revolute joint of claim 7, further comprising a tensioning assembly that is mounted in the housing, wherein the tensioning assembly comprises:
a swing arm that is rotatably coupled to the housing at an axis offset from the stator axis and from the output shaft axis;
an idler pulley that is rotatably mounted to the swing arm at a distance from the axis of the swing arm; and
a tensioning adjustment device that engages the swing arm for setting pressure of the idler pulley against the toothed belt;
wherein the idler pulley is disposed against the toothed belt between the drive pulley and the output pulley.

9. The revolute joint of claim 7, further comprising a slip ring coaxial with the output shaft axis that has a first portion that is fixed with respect to the housing and that has a second portion that is fixed with respect to the output shaft, the slip ring configured to transmit electrical power and electrical signals.

10. The revolute joint of claim 7, further comprising an inverter that is fixed to the housing and is electrically connected to the stator coils of the apparatus.

11. The revolute joint of claim 10, further comprising a slip ring that has a first portion that is fixed with respect to the housing and that has a second portion that is fixed with respect to the output shaft, wherein the slip ring is electrically connected to the inverter.

12. The revolute joint of claim 7, wherein the axis of the output shaft is parallel to the axis of the driven shaft.

13. The revolute joint of claim 7, further comprising:
a motor encoder that is associated with the rotor, the nested motor coaxial with a driven shaft axis; and
a non-transitory computer readable medium that is encoded with computer-executable instructions for implementing a target sequence of rotary movements around the output shaft axis, the instructions comprising instructions for:
receiving the target sequence of rotary movements of the output shaft;
receiving the orientation of the output shaft relative to the joint, a magnetic field, and/or gravity;
translating the target sequence of rotary movements to a sequence of motor commands that rotates the motor about the driven shaft axis; and
driving the motor according to the sequence of motor commands.

14. The revolute joint of claim 13, wherein the encoder is one of a Hall effect encoder, an optical encoder, a magnetic encoder, or an inductive, capacitive, or resistive encoder.

15. The revolute joint of claim 7, further comprising a fluid connector routed along and through an axial opening of the output shaft, wherein the fluid connector includes a fluid slip joint.
